(19) United States
(12) Patent Application Publication
(10) Pub. No.: US 2013/0246219 A1
(43) Pub. Date: Sep. 19, 2013

(54) RANKING AND OPTIMIZING TRIPS

(71) Applicants: John Robert MISHANSKI, San Francisco, CA (US); Girts FOLKMANIS, San Francisco, CA (US)

(72) Inventors: John Robert MISHANSKI, San Francisco, CA (US); Girts FOLKMANIS, San Francisco, CA (US)

(73) Assignee: GOOGLE INC., Mountain View, CA (US)

(21) Appl. No.: 13/420,107

(22) Filed: Mar. 14, 2012

(51) Int. Cl. G06Q 30/00

(52) U.S. Cl. 705/26.9

(57) ABSTRACT

Ranking and optimizing trips for several items to be purchased is described. In one embodiment, a method for ranking shopping trips includes receiving geographic location information, receiving a product item identifier for products to be purchased, searching inventories of one or more retailers for the products to be purchased and compiling search results, generating one or more shopping trips based on the search results and a compilation metric, ranking the one or more shopping trips according to a least cost metric, and displaying the ranked shopping trips. In other aspects, ranking and optimizing shopping trips further comprises calculating at least one of a total cost for the products to be purchased, a distance and time estimate for each of the shopping trips, a time cost for each of the shopping trips, and a transportation cost for each of the shopping trips.

### TECHNICAL FIELD

The present invention generally relates to ranking and optimizing shopping trips for a plurality of items to be purchased. When a purchaser desires to purchase a plurality of items, the present invention may search inventories of one or more retailers and compile search results into shopping trips to purchase the items. The shopping trips may be ranked according to cost metrics so that the purchaser can quickly select the most cost effective trip.

### BACKGROUND

When a purchaser desires to purchase a plurality of items, especially in a retail setting, it may be difficult for the purchaser to determine the most cost effective shopping trip to purchase the plurality of items. As one example, a purchaser may desire to purchase several grocery items. If three grocery stores are within seven miles of the purchaser's home, the purchaser may seek to purchase one or more of the grocery items at each of the three grocery stores, in an effort to reduce the total cost spent for the grocery items. However, it may be difficult for the purchaser to determine the respective prices for the items at the three grocery stores without making several trips to each. Also, beyond the costs of the respective grocery items, there are costs associated with traveling to each of the grocery stores. In some cases, the costs to travel to a particularly distant grocery store may outweigh the benefit obtained by finding a lower cost for one or more items purchased there. These costs are particularly difficult for a purchaser to take into account quickly and easily.

The difficulties of determining a cost effective shopping trip are further compounded when the list of items to be purchased is not homogeneous. In other words, if a purchaser desires to purchase eggs, milk, a compact disc, and motor oil, the purchaser will have more choices in retail outlets. Particularly, the purchaser may be able to choose from three grocery stores, two stores that sell compact discs, and three stores that sell automotive parts. As a further complication, some stores may sell both compact discs and automotive parts, for example, and the store that sells milk at the best price may be distant from the store that sells motor oil at the best price while the store that sells eggs at the best price may be close to the store that sells compact discs for the best price.

As noted above, the costs of a shopping trip may include more than simply the costs of the items to be purchased. The costs may include time, fuel, and transportation costs, for example. In combination with the complexities of a non-homogeneous shopping list, a purchaser may not choose to spend the amount of time necessary to determine the most cost effective shopping trip. As such, an automated system of determining, ranking, and optimizing shopping trips would be beneficial to purchasers of items, especially at retail locations and for non-homogeneous shopping lists.

### SUMMARY

In one embodiment, a method for ranking shopping trips is described including receiving geographic location information, receiving a product item identifier for each of a plurality of products to be purchased, searching inventories of one or more retailers for the products to be purchased and compiling search results, generating one or more shopping trips based on the search results and a compilation metric, ranking the one or more shopping trips according to a least cost metric, and displaying the ranked shopping trips. In one aspect, generating one or more shopping trips may further comprise calculating at least one of a total cost for the products to be purchased, a distance and time estimate for each of the shopping trips, a time cost for each of the shopping trips, and a transportation cost for each of the shopping trips, and generating one or more shopping trips further comprises summing each of the calculated costs. In another aspect, the time cost of each of the shopping trips may be calculated based on a determined value of an hour of time to a purchaser of the plurality of products, and the transportation cost of each of the shopping trips may be calculated based on one of the cost of walking, driving a personal automobile, and taking public transportation.

In certain embodiments, the least cost metric may comprise one of least overall total cost, least cost of the items to be purchased, least time, least number of retailers to attend, least total distance, and least transportation cost, and the compilation metric may comprise one of least overall total cost, least cost of the items to be purchased, least time, least number of retailers to attend, least total distance, and least transportation cost. In other embodiments, the compilation metric may comprise at least two compilation metrics among overall total cost, least cost of the items to be purchased, least time, least number of retailers to attend, least total distance, and least transportation cost.

In another embodiment, a computer-readable storage device is described. The computer-readable storage device storing computer readable instructions thereon is that, when executed by a processor, direct the processor to perform a method for ranking shopping trips, including receiving geographic location information, receiving a product item identifier for each of a plurality of products to be purchased, searching inventories of one or more retailers for the products to be purchased and compiling search results, generating one or more shopping trips based on the search results and a compilation metric, ranking the one or more shopping trips according to a least cost metric, and displaying the ranked shopping trips. In connection with the another embodiment, generating one or more shopping trips may further comprise calculating at least one of a total cost for the products to be purchased, a distance and time estimate for each of the shopping trips, a time cost for each of the shopping trips, and a transportation cost for each of the shopping trips, and generating one or more shopping trips further comprises summing each of the calculated costs. In another aspect, the time cost of each of the shopping trips may be calculated based on a determined value of an hour of time to a purchaser of the plurality of products, and the transportation cost of each of the shopping trips may be calculated based on one of the cost of walking, driving a personal automobile, and taking public transportation.

In certain embodiments, the least cost metric may comprise one of least overall total cost, least cost of the items to be purchased, least time, least number of retailers to attend, least total distance, and least transportation cost, and the compilation metric may comprise one of least overall total cost, least cost of the items to be purchased, least time, least number of retailers to attend, least total distance, and least transportation cost. In other embodiments, the compilation metric may comprise at least two compilation metrics among overall total cost, least cost of the items to be purchased, least time, least number of retailers to attend, least total distance, and least transportation cost.

In still another embodiment, an apparatus for ranking shopping trips is described including a location input module configured to receive geographic location information, a product input module configured to receive a product item identifier for each of a plurality of products to be purchased, a search and compilation engine configured to search inventories of one or more retailers for the products to be purchased, compile search results, and generate one or more shopping trips based on the search results and a compilation metric, a ranking module configured to rank the one or more shopping trips according to a least cost metric, and an output module configured to display the ranked shopping trips. In one aspect, the apparatus may further comprise a cost module configured calculate a total cost for the products to be purchased, calculate a distance and time estimate for each of the shopping trips, calculate a time cost for each of the shopping trips, and calculate a transportation cost for each of the shopping trips. In another aspect, the time cost of each of the shopping trips may be calculated based on a determined value of an hour of time to a purchaser of the plurality of products, and the transportation cost of each of the shopping trips may be calculated based on one of the cost of walking, driving a personal automobile, and taking public transportation.

These and other aspects, objects, features, and embodiments will become apparent to a person of ordinary skill in the art upon consideration of the following detailed description of illustrative embodiments exemplifying the best mode for carrying out the invention as presently perceived.

### BRIEF DESCRIPTION OF THE DRAWINGS

For a more complete understanding of the invention and the advantages thereof, reference is now made to the following description, in conjunction with the accompanying figures briefly described as follows:

FIG. 1 illustrates a system for ranking and optimizing shopping trips;

FIG. 2 illustrates a method for ranking and optimizing shopping trips;

FIG. 3 further illustrates a method for ranking and optimizing shopping trips;

FIG. 4 illustrates a method for generating shopping trips;

FIG. 5 illustrates a method for calculating costs of aspects of shopping trips;

FIG. 6 illustrates one example of a ranked display of shopping trips;

FIG. 7 illustrates another example of a ranked display of shopping trips; and

FIG. 8 illustrates a general purpose computer configured to implement one or more aspects of a system for ranking and optimizing shopping trips.

### DETAILED DESCRIPTION

In the following paragraphs, the present invention will be described in further detail by way of example with reference to the attached drawings. In the description, well known components, methods, and/or processing techniques are omitted or briefly described so as not to obscure the invention. As used herein, the “present invention” refers to any one of the embodiments of the invention described herein and any equivalents. Furthermore, reference to various feature(s) of the “present invention” is not to suggest that all embodiments must include the referenced feature(s).

Among embodiments, some aspects of the present invention are implemented by a computer program executed by one or more processors, as described and illustrated. As would be apparent to one having ordinary skill in the art, the present invention may be implemented, at least in part, by computer-readable instructions in various forms, and the present invention is not intended to be limiting to a particular set or sequence of instructions executed by the processor.

Embodiments of the present invention comprise a search and compilation engine configured to receive geographic location information, receive a product item identifier for each of a plurality of products to be purchased, search inventories of one or more retailers for the products to be purchased and compile search results based on a compilation metric, generate one or more shopping trips based on the search results, rank the one or more shopping trips according to a least cost metric, and display the ranked shopping trips.

The geographic location information may be received in various forms, such as via GPS coordinates, zip code, and street address, for example. In that context, the geographic location information may be determined automatically or manually entered. The product item identifiers may also be received in various forms, such as product identification number, product name, product type, and brand name, for example. Further, the product item identifiers may be entered in various manners such as by voice, text, photograph, and barcode scanner, for example. In one aspect, the invention may comprise a disambiguation module configured to resolve any ambiguities associated with product item identifiers.

After the geographic location and product item identifiers are received, the search and compilation engine searches inventories of one or more retailers for the products to be purchased. In one embodiment, for effective use of computing resources, the inventory search may be limited to retailers within a certain predetermined distance from the received geographic location. The engine compiles the results of the inventory search. For example, the engine identifies each store that currently sells the products to be purchased and the price of each product at each retailer. After the respective price, at each store, of each product to be purchased is identified, the engine turns to compiling the search results into one or more shopping trips.

Generally, the engine seeks to generate shopping trips according to a compilation metric or ordered priority of compilation metrics. The compilation metrics may be selected from among the non-limiting example group of overall total cost, least cost of the items to be purchased, least time, least number of retailers to attend, least total distance, and least transportation cost. As one example, the engine may generate shopping trips according to least overall cost as a single compilation metric. In that case, the engine determines, using the search results, shopping trips that results in low total cost overall, regardless of the total number of retail stores attended, the distance between the stores, or the time for the shopping trips.

As another example, the engine may generate shopping trips according to a least overall cost as a primary compilation metric and least time as a secondary compilation metric. In that case, the engine determines, using the search results, shopping trips that result in low total cost overall, while taking into account an estimate of time required for the shopping trip.

While generating shopping trips, the search engine relies on and refers to a cost module configured to calculate costs associated with aspects of the trips. For example, the cost module may be configured to calculate a total cost for the products to be purchased, a distance and time estimate for each of the shopping trips, a time cost for each of the shopping trips, and a transportation cost for each of the shopping trips. Using the costs calculated by the cost module, the search engine is able to generate shopping trips pursuant to the selected compilation metrics.

After the shopping trips are generated, a ranking module ranks the shopping trips based on one or more least cost metrics, and an output module outputs the ranked results for display. The ranking module is further configured to receive a request to re-rank the displayed results and re-rank the shopping trips in response to the request, and the output module is further configured to output the re-ranked results for display. Additionally, the engine is further configured to receive an updated group of compilation metrics and regenerate the shopping trips in response to the updated group. In turn, the ranking and output modules are configured to rank and output the regenerated shopping trips.

According to further aspects, the cost module may take into account a value of an individual's time when calculating costs. Additionally, the cost module may be further configured to take into account several means of transportation including personal automobile, walking, and taking public transportation. Combining two cost aspects, the cost module may calculate the time necessary for an individual to take public transportation vs. a personal automobile, and further calculate respective costs of each based on the value of the individual's time. After a purchaser is satisfied with the results for a particular set of complication metrics and ranking of the shopping trips, the purchaser may select one of the shopping trips to receive details of the selected shopping trips. The details may include the locations of each of the stores on the trip and directions to each store, in sequence, for example.

Turning now to the drawings, in which like numerals indicate like elements throughout, exemplary embodiments of the invention are described in detail.

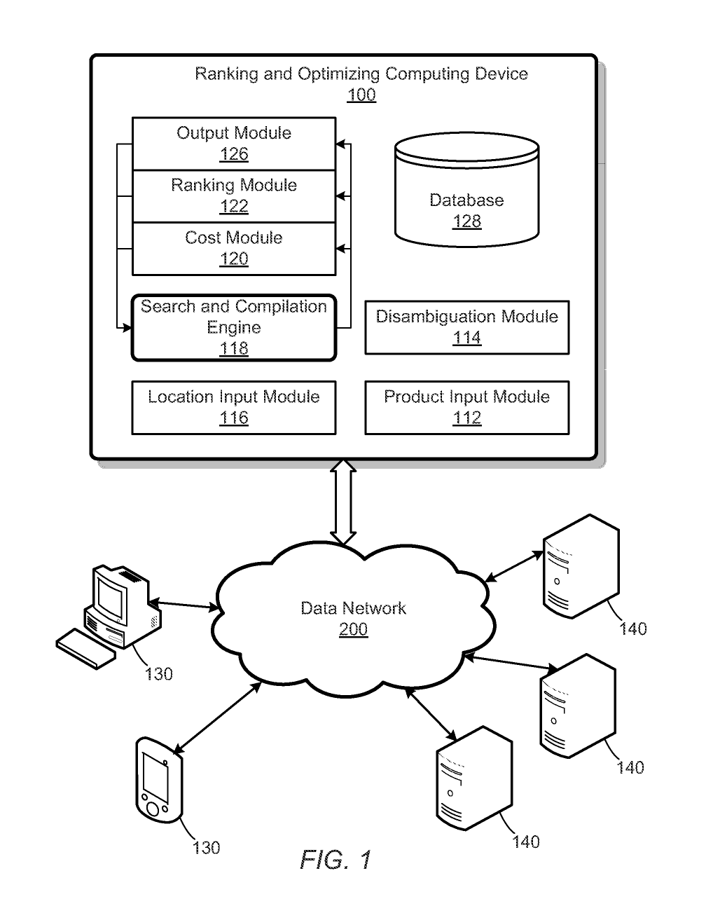

FIG. 1 illustrates a system for ranking an optimizing shopping trips according to one embodiment of the present invention. The system includes a ranking and optimizing computing device 100, client computing devices 130, and servers 140. The ranking and optimizing computing device 100, client computing devices 130, and servers 140 are communicatively coupled by a data network 220, such as the Internet, and may be implemented by general purpose computers, servers, or similar computing devices. The client computing devices 130 may comprise any type of client computing device such as desktop and laptop computers, cellular telephones, tablet computers, and point of sale devices, for example. The data network 200 comprises, in various embodiments, public and private wired and wireless networks, as understood in the art, and the client computing devices 130 may be coupled to the data network 200 using wired and wireless communication means. It is noted that, in general, the system for ranking an optimizing shopping trips may be implemented using any type of computing devices without limitation, as understood by one having ordinary skill in the art.

The ranking and optimizing computing device comprises a product input module 112, a disambiguation module 114, a location input module 116, a search and compilation engine 118, a cost module 120, a ranking module 122, an output module 124, and a database 128. In operation, the ranking and optimizing computing device receives geographic location information and product item identifiers for each of a plurality of products to be purchased, resolves ambiguities associated with the product item identifiers, searches inventories of one or more retailers for the products to be purchased and compiles search results, generates one or more shopping trips based on the search results, ranks the one or more shopping trips according to a least cost metric, and displays the ranked shopping trips.

The product input module 112 is configured to receive product item identifiers for each of a plurality of products to be purchased. After entry, the plurality of products to be purchased comprises a list of products or “shopping list” of items to be purchased. As used herein, the term “product” refers to any type of goods or services which may be purchased, without limitation. The product input module 112 is configured to receive the product item identifiers in various forms. For example, using one of the client computing devices 130, a purchaser may provide a product identification number, such as a Stock Keeping Unit (“SKU”) number, an International Standard Book Number (“ISBN”), or a manufacturer model number. Additionally, the purchaser may provide a product or item names or product categories such as product type or brand name to the product input module 112. In one aspect, the client computing devices 130 may include bar scanners or cameras to scan bar codes of products to be purchased, and the identification numbers of the bar codes may be communicated to the product input module 112. Additionally, a camera may be used to upload a photo of a product to be purchased, and the product input module may be configured to determine a product to be purchased based on the photo of the item. In another aspect, the client computing devices 130 may prompt a purchaser to dictate product identification terms, and the product input module 112 is configured to convert the dictated terms into text for entry as one or more product item identifiers.

For ease of use, a history of one or more product lists may be stored to the database 128 by the product input module 112 for a particular purchaser, and the product input module 112 may be configured to present the saved product lists to the purchaser upon request, for quick generation of a shopping list of frequently purchased items. In other aspects, the product input module 122 may recognize more than one product based on a brand name or product category. That is, the product input module may be further configured to receive and identify a product item identifier for CLOROX BLEACH, and associate, in the alternative, CLOROX BLEACH and generic bleach as one item to be purchased.

The disambiguation module 114 is configured to resolve any ambiguities associated with the product item identifiers received by the product input module 112. For example, if a purchaser enters a broad product category such as “soap,” the disambiguation module 114 is configured to present the purchaser with a list of types of soap, for selection. The list of types of soap may be generated by the disambiguation module 114 with reference to data stored in the database 128 or the servers 140. After the list is presented to the purchaser, the purchaser may make one or more selections from the list, until a particular item of soap is selected for addition to the list of products to be purchased. It is noted that the disambiguation module 114 may resolve ambiguities without using a list of items for selection. For example, the disambiguation module 114 may auto-correct ambiguous product item entries automatically, with an option to replace the automatically corrected item entry.

In one aspect, the disambiguation module 114 is configured to determine a particular item a purchaser want to purchase based on the purchaser's broad definition of a product type and the purchaser's prior history of items purchased. That is, the disambiguation module 114 is further configured to store user preferences for a particular purchaser in the database 128 and, when the purchaser enters the broad category of “soap,” select the particular item of soap the purchaser wishes to purchase based on the purchaser's prior history of purchase of a particular brand of soap. In another aspect, the disambiguation mode 114 is further configured to identify product terms which are ambiguous. For example, a product term “apple” may refer to a piece of fruit or a product manufactured by APPLE COMPUTER. In this case, the disambiguation module 114 may identify the ambiguity and offer a query to the purchaser to address the ambiguity or select a product based on the purchaser's prior history of purchases, for example.

The location input module 116 is configured to receive geographic location information. Among examples, the geographic location information may be associated with a current geographic location of a purchaser, a geographic location of the purchaser's home, or a geographic location of the purchaser's office. The location input module 116 may receive the geographic location information in various forms such as by city, cross-street, street address, zip code, Global Positioning System (“GPS”) coordinates, or geographic landmark, for example. The purchaser may provide the geographic information to the location input module 116 using the client computing device 130. When the client computing device 130 includes a GPS receiver, the latitude and longitude coordinates determined by the GPS receiver may be provided to the location input module 116. Also, various locations may be stored in the database 128 for a particular purchaser, for quick reference.

The search and compilation engine 118 (“the engine 118”) is configured to search inventories of one or more retailers for a list of product items to be purchased. The engine 118, when searching the inventories of the retailers for the products to be purchased, may reference the database 128 and/or the servers 140. For example, each retailer may maintain a list of items in stock, updated daily by inventory shipments and sales data, along with respective prices for the items in stock. As such, the servers 140 may comprise databases of product items in stock for a plurality of retailers and for each of a plurality of retail locations. The engine 118 may connect to the servers 140 via an API, web services interface, or other interface as understood in the art and search the inventories of the retailers for the items to be purchased.

For each retailer, the engine 118 maintains a list of all items to be purchased that are in stock at the retailer and the respective price of each. The engine 118 may search the inventories of all retail locations until the search is exhausted. It is noted however, that the engine 118 may limit the search based on pragmatic and/or efficiency factors. For example, the engine 118 may limit the search of retailers to grocery stores if the list of products to be purchased includes only groceries. In that case, the engine 118 limits the search to grocery stores because items such as eggs and milk cannot typically be purchased at a hardware store, for example. As another example, the engine 118 may limit the search to stores within a predetermined distance from a geographic location determined by the location input module 116, to limit the number of stores searched for efficiency.

In addition to maintaining the list of all items in stock at each retailer, the engine 118 also retrieves and maintains additional information associated with each retailer, such as the address of each retailer, the hours of operation of each retailer, and the costs of parking at each retailer, for example. The engine 118 compiles the lists of all items in stock and additional information for each retailer into search results which are relied upon by the engine 118 and the cost module 120 to generate a ranked list of shopping trips.

Generally, the engine 118 is configured to generate a plurality of shopping trips according to a compilation metric or an ordered priority of compilation metrics (the “compilation metrics”), with the cost module 120 assisting with the calculation of costs of each of the trips. The compilation metrics may be selected from among the non-limiting example group of least overall total cost, least cost of the items to be purchased, least time, least number of retailers to attend, least total distance, and least transportation cost. Further, the compilation metrics and the priorities of the compilation metrics may be set by default and/or modified by a purchaser, before or after display of the shopping trips.

As one example, the engine 118 may be configured to generate a plurality of shopping trips according to least overall total cost as a single compilation metric. In that case, the engine 118 determines, using the search results and costs calculated by the cost module 120, a plurality of shopping trips that result in low overall total costs, regardless of the number of stores visited, the distance between the stores, or the time required for the shopping trips. After the plurality of shopping trips are generated by the search and compilation engine 118, the ranking module 122 is configured to rank (i.e., sort) the plurality of shopping trips according to the least overall total cost as a least cost metric.

As another example, the engine 118 may be configured to generate a plurality of shopping trips according to least overall total cost as a primary compilation metric and least time as a secondary compilation metric. In that case, the engine 118 may determine, using the search results and costs calculated by the cost module 120, a plurality of shopping trips that result in low overall total cost to the purchaser, while taking into account an estimate of time required for each shopping trip. In other words, in this case, the engine 118 is configured to generate the list of shopping trips based on both the considerations of low overall total cost and low trip time. As such, the engine 118 may not generate a shopping trip that includes a retail location 20 miles away, even if the trip comprises the lowest overall total cost, because the trip requires an unacceptable amount of time.

As noted above, while generating shopping trips, the engine 118 relies on and refers to the cost module 120, which is configured to calculate (i.e., estimate) costs associated with various aspects of the trips. The various aspects of the trips may be predefined by the engine 118 for a general case and modified by a purchaser before or during the generation of shopping trips to be ranked and displayed, as described in further detail below. Additionally or alternatively, the various aspects of the trips may be predefined for each of a plurality of particular purchasers and stored in the database 128. As such, the engine 118 may refer to the default shopping characteristics of a particular purchaser, before generating shopping trips. For example, the engine 118 may identify, with reference to the database 128, that a particular purchaser generally shops using a personal automobile within a range of 10 miles from his or her home or office during 5 and 7 μm, and select compilation metrics accordingly.

In one embodiment, the cost module 120 may be configured to calculate a total cost of a list of products to be purchased for a plurality of shopping trips, a distance and time estimate for each of the shopping trips, a time cost for each of the shopping trips, and a transportation cost for each of the shopping trips. To calculate these costs, the cost module 120 is configured to reference the search results compiled by the engine 118, the database 128, and the servers 140.

More particularly, when calculating the total cost of the products to be purchased, the cost module 120 refers to the costs of the individual items for each of the retailers, as determined by the engine 118 from the database 128 and/or the servers 140. When calculating the distance and time estimate for each of the shopping trips, on the other hand, the cost module 120 is configured to calculate an estimate of a particular shopping trip based on the respective distances between each of the retailers for the particular shopping trip. The estimate may also be based on the method of travel, such as driving a personal automobile, walking, and taking public transportation. In that context, the transportation cost for each of the shopping trips may be based on the cost of fuel, fares, tolls, and parking, for example, depending upon the means of transportation for the trip. The time aspect of an estimate may be based on the method of transportation and the traffic for a particular time of day, with reference to real-time traffic information and public transportation schedules obtained from the servers 140.

When calculating a time cost for each of the shopping trips, the cost module 120 is configured to take into account a value of a purchaser's time. That is, a purchaser may value his or her time according to a dollars/hour metric, such as $10, $20, or $30/hour. The dollars/hour metric may be provided by the purchaser, as an explicit metric, or calculated for the purchaser based on a selection of the purchaser's line of work, as an implicit metric, for example. Thus, in one aspect of cost calculation, the cost module 120 is configured to calculate a time cost of $15 for a shopping trip estimated to require 1.5 hours to complete at a $10/hour rate of a purchaser's time. It should be appreciated here that several aspects of the cost of a shopping trip are interrelated and dependent. In other words, the time cost for a shopping trip may depend, in part, upon a selected method of travel, for example. In connection with the costs calculated by the cost module 120, the engine 118 is able to generate a plurality of shopping trips pursuant to the selected compilation metrics, as noted above.

The ranking module 122 is configured to rank the plurality of shopping trips generated by the engine 118 based on the compilation metrics and/or a selected least cost metric, for example. The ranking module may be configured to rely upon a default least cost metric or reference a least cost metric historically selected by a particular purchaser from the database 128. For example, a particular purchaser may always choose the least cost metric of least total cost overall for ranking, and this selection may be stored as a default selection for the purchaser in the database 128.

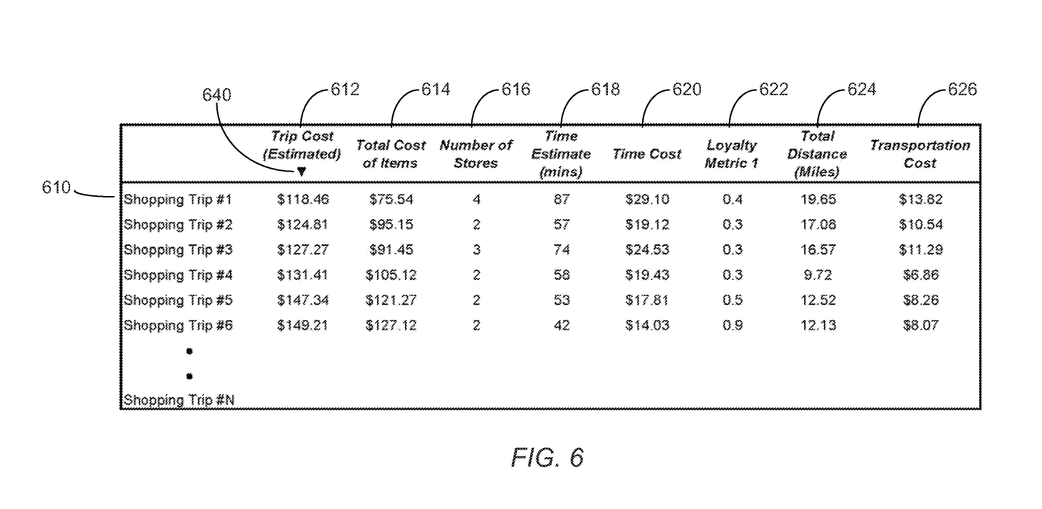

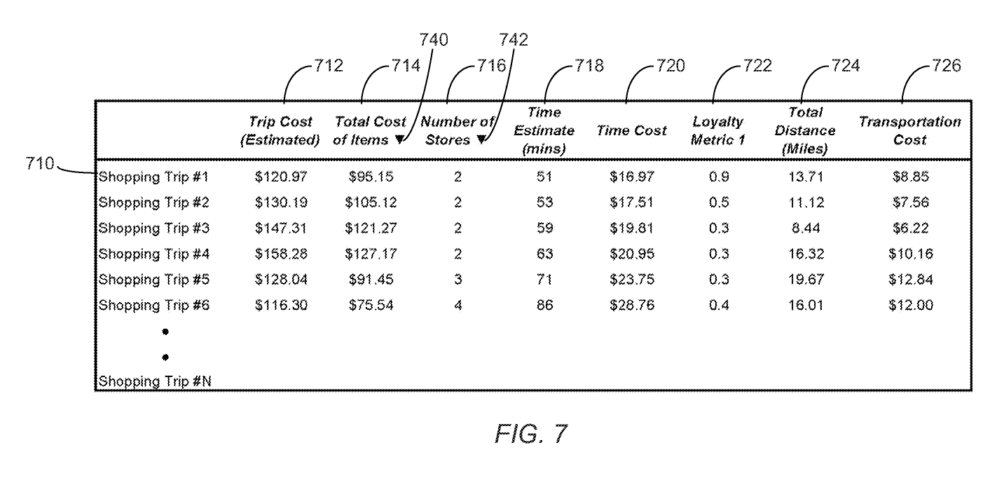

The output module 124 is configured to output the ranked list of shopping trips. In other words, the output module 124 is configured to generate a web page or similarly formatted instructions to the client computing device 130 for rendering. The web page comprises the ranked list of shopping trips to be rendered by a client computing device 130. It is noted that the web page or similarly formatted instructions may comprise HTML, XML, or other markup languages as well as embedded scripts as understood in the art, without limitation. The output module 124 is further configured to communicate the page or other source format to a requesting client computing device 130 for display. As described in further detail below with reference to FIGS. 6 and 7, the ranked list of shopping trips may be displayed with the particulars of each of the shopping trips in categories, including a total overall trip cost of each trip, a total cost of items to be purchased for each trip, a number of stores for each trip, a time estimate for each trip, a time cost for each trip, and a total distance traveled for each trip, among other categories. Additionally, based on a purchaser's preference to purchase items of a particular brand name or shop from particular stores, each shopping trip may further include a loyalty metric. In one embodiment, the ranked list of shopping trips may be sorted or re-ranked by selecting a category for sorting or re-ranking.

It is noted that, even after the ranked list of shopping trips are output for display, a purchaser may submit a further request to the ranking and optimizing computing device 100 to update the ranked list of shopping lists according to a change in compilation metrics relied upon by the engine 118, a change in value of the purchaser's time, or the purchaser's change in the least cost metric relied upon by the ranking module 122, for example.

Alternatively, after the ranked list of shopping trips are output for display, the purchaser may request details for a selected one of the shopping trips without a further request to re-rank or update the ranked list. In that context, the output module 124 is further configured to output the details of the selected shopping list to a requesting client computing device 130, as described in further detail below.

In one embodiment, a purchaser may enter preferences such as preferred products, preferred stores, or preferred means of transportation, for example. The preferences of the purchaser may be stored in the database 128 for reference by the engine 118 when generating shopping trips. Particularly, the engine 118 may prioritize shopping trips using the purchaser's preferred mode of transportation or including stops at the purchaser's favorite stores. Additionally, the engine 118 may prioritize shopping trips that permit the purchaser to purchase preferred brands of products. In this context, the engine 118 also generates a loyalty metric to be displayed in association with each shopping trip, as described in further detail below with reference to FIGS. 6 and 7. Thus, a purchaser is able to quickly reference shopping trips which are closely aligned with the purchaser's preferred products, stores, and modes of transportation, for example.

Using the system for ranking and optimizing shopping trips, a purchaser is able to make a cost-effective selection of a particular shopping trip from a plurality of trips, as the purchaser is provided with the particulars of each of the shopping trips. Further, the purchaser is easily able to discern the advantages and disadvantages to each of the shopping trips and select one based on the purchaser's needs.

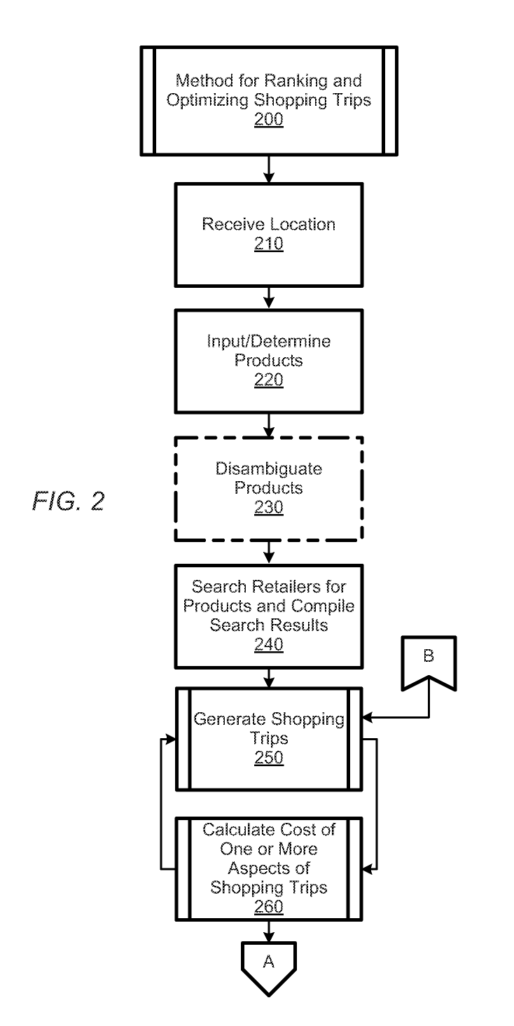

Before turning to the process flow diagrams of FIGS. 2-5, it is noted that the present invention may be practiced using an alternative order of the steps illustrated in FIGS. 2-5. That is, the process flows illustrated in FIGS. 2-5 are provided as examples only, and the present invention may be practiced using process flows that differ from those illustrated. Additionally, it is noted that not all steps are required in every embodiment. In other words, one or more of the steps may be omitted or replaced, without departing from the spirit and scope of the invention. In alternative embodiments, steps may be performed in different orders, in parallel with one another, or omitted entirely, and/or certain additional steps may be performed without departing from the scope and spirit of the invention.

Turning to FIG. 2, a method 200 for ranking and optimizing trips is illustrated. At the outset, one of the client computing devices 130 requests access to the ranking and optimizing computing device 100 via the data network 200 using a web browser, for example, in accordance with the commands or instructions of a purchaser. In alternative or modified embodiments, the client computing device 130 may access the ranking and optimizing computing device 100 via an Applications Programming Interface (“API”) or other similar interface. In return, the ranking and optimizing computing device 100 serves a web page or other instructions to be rendered by the client computing device 130. The web page is rendered by the client computing device 130 to facilitate receipt of a geographic location from the purchaser by the location input module 116 at step 210. As noted above, the geographic location information may be received in various forms from the purchaser, such as via GPS coordinates, zip code, and street address, for example. In various embodiments, the geographic location information may also be received by the location input module 116 automatically from a GPS of the client computing device 130 or by default based on a stored geographic location in the database 128.

At step 220, the product input module 112 receives product item identifiers for each of a plurality of products to be purchased. As noted above, the product input module 112 is configured to receive product item identifiers in various forms such as SKU numbers, ISBN numbers, manufacturer model numbers, product or item names, product categories, or brand names. The product input module 112 may also receive product item identifiers using bar scanners, cameras, or microphones of the client computing device 130.

After receipt of the product item identifiers for a plurality of products to be purchased, the disambiguation module 114 disambiguates any ambiguous product item identifiers at step 230. As noted above, if the purchaser enters a broad product category such as “soap,” the disambiguation module 114 presents the purchaser with a list of types of soap, for selection. After the list is presented to the purchaser, the purchaser may select a particular item of soap from the list to be purchased. In other words, the disambiguation module 114 clarifies ambiguities stemming from broad product categories, product item identifier dualities, and indefinite product item identifiers, for example, at step 230.

After a list of a plurality of products to be purchased is received at step 220 and, as necessary, disambiguated at step 230, the engine 118 searches retailers for the products at step 240. Again, the term “product” as used herein refers to any type of goods or services which may be purchased, without limitation. The engine 118 references the database 128 and/or the servers 140 when searching the retailers for the products. As noted above, the engine 118 may limit the search based on pragmatic and/or efficiency considerations.

During step 240, the engine 118 compiles search results including a list of all items in stock at each retailer. Further, the engine 118 also retrieves and maintains additional information associated with each retailer, such as the address of each retailer, the hours of operation of each retailer, and the costs of parking at each retailer, for example. The engine 118 compiles the lists of all items in stock and additional information for each retailer into search results which are relied upon by the engine 118 and the cost and ranking modules 120 and 122 to generate a ranked list of shopping trips at steps 250 and 260.

At steps 250 and 260, the engine 118 generates a plurality of shopping trips with the assistance of the cost module 120. Generally, the engine 118 is configured to generate a list of shopping trips according to one or more compilation metrics, with the cost module 120 assisting in calculations. As noted above, the compilation metrics may be selected from among the non-limiting example group of overall total cost, total item cost, time, number of retailers, total distance, and transportation cost. Further, the compilation metrics and the priorities of the compilation metrics may be set by default and/or modified by a purchaser, before or after display of the shopping trips.

As a first example, at steps 250 and 260, the engine 118 generates a plurality of shopping trips according to a low overall total cost as a single compilation metric. That is, the engine 118 determines, using the search results compiled by the engine 118 and the costs calculated by the cost module 120, a plurality of shopping trips that result in low overall total cost, regardless of other metrics such as the number of stores visited, the distance between the stores, or the time required for the shopping trips.

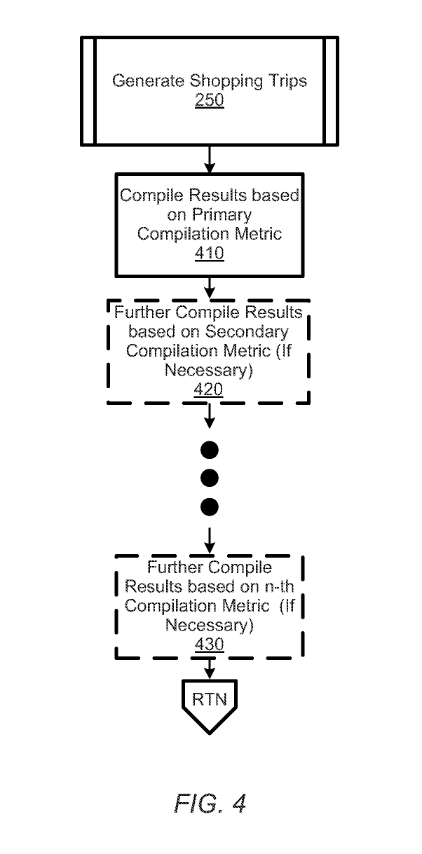

With reference to FIG. 4, a method for generating shopping trips at step 250 is further illustrated in an exploded view. Further to the first example, the engine 118 generates a plurality of shopping trips according to a low overall total cost as a primary (and only) compilation metric at step 410. Because secondary compilation metrics are not relied upon, as designated by the purchaser or by default, the remaining steps in FIG. 4 are not processed. More particularly, the engine 118 is configured to generate the shopping trips from the compiled search results based on only low overall total cost at step 410, regardless of other metrics. The generation of shopping trips by the engine 118 based on more than one metric at steps 410, 420, and 430, for example, is described in further detail below with reference to FIG. 7.

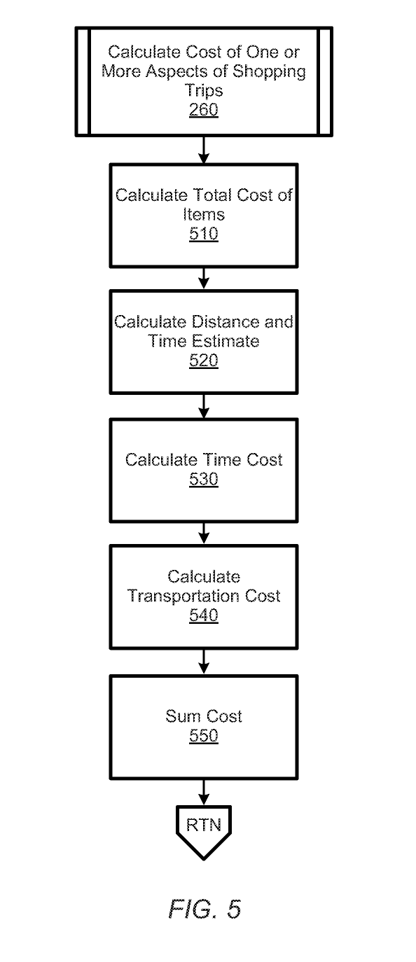

With reference to FIG. 5, a method for calculating costs of aspects of shopping trips at step 260 is further illustrated in an exploded view. Further to the first example, the cost module 120 calculates a total cost of the products to be purchased during shopping trips at step 510, calculates distance and time estimates for shopping trips at step 520, calculates a time cost for shopping trips at step 530, calculates transportation costs for shopping trips at step 540, and sums the costs at step 550.

In further detail, the calculation of a total cost of the products to be purchased during a shopping trip at step 510 may be calculated by the cost module 120 based on the costs of the respective items to be purchased at respective retailers for the trip, according to the search results compiled by the engine 118. The calculation of a total distance and time estimate for a shopping trip at step 520 may be calculated by the cost module 120 based on the total distance between stores for the trip, an estimate of traffic, and an explicit or implicit selection of a means of transportation for the trip, for example. Thus, it is noted that the cost module 120 may be configured to reference the servers 140 to determine data such as the total distance between the stores for the trip and the estimate for traffic during step 520. The calculation of a time cost for a shopping trip at step 530 may be calculated by the cost module 120 based on the time estimate in step 520 and implicit and explicit feedback from the purchaser indicative of the value of the individual's time, for example, and other information. The calculation of transportation cost for a shopping trip at step 540 may be calculated by the cost module 120 based on the cost of fuel, fares, tolls, and parking, for example, depending upon the means of transportation for the trip. The calculation of the sum of costs at step 550 comprises a summation of the costs calculated at steps 510, 520, 530, 540, and 550, for example.

It is noted that the steps illustrated in FIGS. 4 and 5 for methods 250 and 260 are for example only. In various embodiments, some steps may occur in alternative orders or in parallel, omitted, or be intertwined among FIGS. 5 and 6 depending upon the selection of compilation metrics, for example, as would be understood by one having ordinary skill in the art.

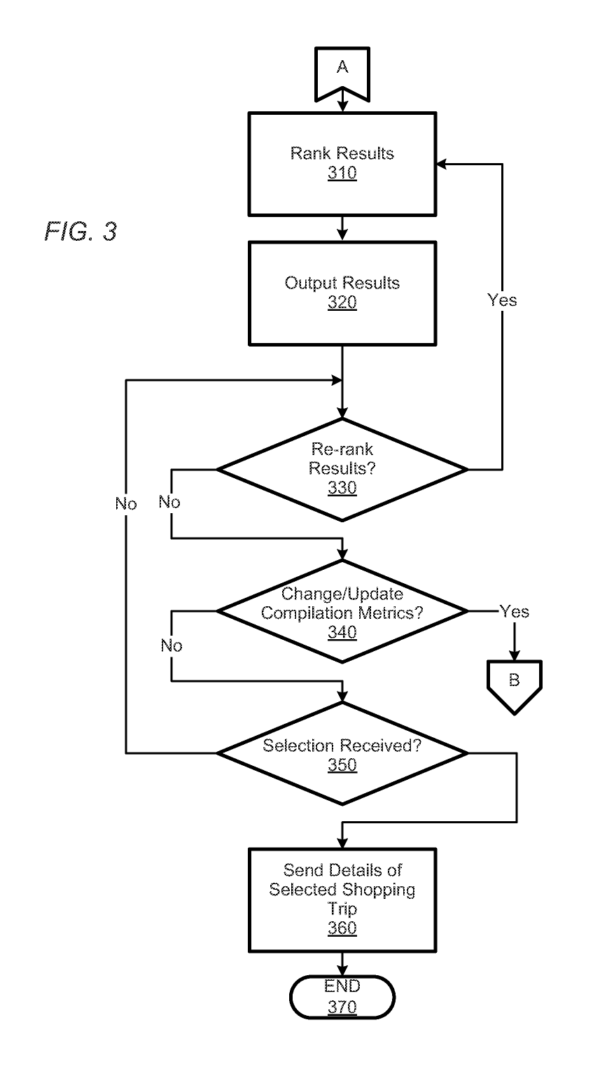

After the plurality of shopping trips are generated at step 250 by the engine 118 with reference to the calculation of costs by the cost module 120 at step 260, the ranking module 122 ranks the plurality of shopping trips according to the least overall total cost metric at step 310 of FIG. 3 and the output module 126 outputs the ranked list of shopping trips at step 320 of FIG. 3.

Referring to FIG. 6, one example of a display of ranked shopping trips is illustrated. According to the first example above, several shopping trips #1-N are illustrated in FIG. 6, with reference 610 designating shopping trip #1, the shopping trip having a highest rank according to least overall cost. The list of shopping trips illustrated in FIG. 6 represents an example list generated by the engine 118, as noted above, with reference to a low overall total cost as a single compilation metric. Further, list of shopping trips illustrated in FIG. 6 was ranked by the ranking module 122 for lowest overall total cost, as noted by the ascending arrow 640 in column 612. For each of the shopping trips, the total estimated trip cost is illustrated in column 612, and the total cost of the items purchased, the number of stores, the time estimate, the time cost, the loyalty metric, the total distance, and the transportations costs are also illustrated in columns 614, 616, 618, 620, 622, 624, and 626, respectively. It is noted that the display of ranked shopping trips may comprise more or fewer columns. For example, the loyalty metric column may be omitted in some displays, or an additional column may be included for mode of transportation.

In this case, shopping trip #1 is the lowest overall total cost shopping trip, at $118.46. Shopping trip #1 requires shopping at four stores during an estimated time period of 87 minutes. In comparison, shopping trip #2 is the next lowest overall total cost shopping trip, at $124.81. Thus, the purchaser may choose shopping trip #1 to purchase the plurality of products to be purchased. In this case, the purchaser may make a selection of shopping trip #1 using the client computing device 130 at step 350, without re-ranking the list of shopping trips at step 330 or changing the compilation metrics at step 340.

After selection of shopping trip #1 by the purchaser at step 350, the process proceeds to step 360 where the output module 124 sends the details of shopping trip #1 to the client computing device 130. For example, the output module 124 may send a sequence of turn-by-turn instructions for driving an automobile, instructions for walking or taking public transportation, or waypoints of retail locations where items are to be purchased—so that the client computing device 130 may provide navigation instructions to the purchaser using GPS navigation software or similar applications. After the client computing device 130 receives the details of shopping trip #1, the process ends at step 370.

Alternatively, with reference again to FIG. 6, the purchaser may note that the time required for shopping trip #2 is substantially less than shopping trip #1, at 57 minutes vs. 87 minutes. This difference is also reflected in the time cost column 620 of FIG. 6. As such, the purchaser may select shopping trip #2 at step 350, and the output module 124 will send the details of shopping trip #2 to the client computing device 130 at step 360. It is also noted that the purchaser may elect to re-rank the ranked list of shopping trips at step 330 in ascending or descending order based on any of the categories 612, 614, 616, 618, 620, 622, 624, and 626. If a command to re-rank is received by the purchaser via the client computing device 130 at step 330, the process proceeds back to step 310, where the ranking module 122 re-ranks the shopping lists based on the command, and the re-ranked list of shopping trips is output again at step 320.

As context for a second example, the purchaser may decide to change the compilation metric(s) by which the engine 118 compiled results and generated the shopping lists. If so, the purchaser may update setting on a web page, for example, using radio buttons, sliders, text entry fields, or other means as understood in the art, without limitation, to change the compilation metrics. In turn, it is identified at step 340 that the compilation metrics have changed, and the process proceeds back to steps 250 and 260 for generation of shopping trips by the engine 118 with reference to costs calculated by the cost module 120.

As the second example, at steps 250 and 260, the engine 118 generates a plurality of shopping trips according to a low cost of the items to be purchased as a primary compilation metric and low number of stores as a secondary compilation metric. That is, the engine 118 determines, using the search results compiled by the engine 118 and the costs calculated by the cost module 120, a plurality of shopping trips that result in low cost of the items to be purchased, while taking into account the number of retail stores attended for each shopping trip. After the plurality of shopping trips are generated by the engine 118 using the primary and secondary compilation metrics with reference to the calculation of costs at steps 250 and 260, the ranking module 122 ranks the plurality of shopping trips according to the least cost of the items to be purchased and the least number of stores attended at step 310 of FIG. 3 and the output module 126 outputs the ranked list of shopping trips at step 320 of FIG. 3.

Referring back to FIG. 4 for the second example, the engine 118 generates a plurality of shopping trips according to a low cost of the items to be purchased as a primary compilation metric at step 410 and also generates the plurality of shopping trips according to a low number of stores as a secondary compilation metric at step 420. It is noted that additional compilation metrics may be relied upon by the engine 118, and the engine may further generate shopping trips according to the additional metrics at step 430, for example. More particularly, the engine 118 is configured to generate the shopping trips from the compiled search results based on both low cost of the items to be purchased and low number of stores attended at steps 410 and 420.

Referring to FIG. 7, another example of a display of ranked shopping trips is illustrated. According to the second example above, several shopping trips #1-N are illustrated in FIG. 7, with reference 710 designating shopping trip #1, the shopping trip having a highest rank. The list of shopping trips illustrated in FIG. 7 represents an example list generated by the engine 118, as noted above, with reference to a cost of the items to be purchased and number of stores attended as compilation metrics. Further, the list of shopping trips illustrated in FIG. 7 was ranked by the ranking module 122 for lowest cost of the items to be purchased and lowest number of stores, as noted by the ascending arrows 740 and 742 in columns 714 and 716. For each of the shopping trips, the total estimated trip cost is illustrated in column 712, and the total cost of the items purchased, the number of stores, the time estimate, the time cost, the loyalty metric, the total distance, and the transportations costs are also illustrated in columns 714, 716, 718, 720, 722, 724, and 726, respectively.

In this case, shopping trip #1 represents a balance between low cost of the items to be purchased and low number of stores to attend, at $95.15 and 2, respectively. Shopping trip #1 only requires shopping at two stores during an estimated time period of 51 minutes. It is noted that shopping trip #1 is not the lowest cost trip overall or even the lowest total cost of items trip overall. Rather, shopping trip #6 comprises the lowest cost trip overall, but with a requirement to attend four stores. However, shopping trip #1 represents a balance between low cost of the items to be purchased and low number of stores to attend, as determined by the selected compilation metrics of the purchaser.

It is again noted that the purchaser may elect to re-rank the ranked list of shopping trips at step 330 in ascending or descending order based on any of the categories 712, 714, 716, 718, 720, 722, 724, and 726. If a command to re-rank is received by the purchaser via the client computing device 130 at step 330, the process proceeds back to step 310, where the ranking module 122 re-ranks the shopping lists based on the command, and the re-ranked list of shopping trips is output again at step 320.

In this case, the purchaser may select shopping trip #2 to purchase the items to be purchased, without re-ranking. After selection of shopping trip #2 by the purchaser, the process proceeds to step 350 where the output module 124 sends the details of shopping trip #2 to the client computing device 130, similarly as described above. After the client computing device 130 receives the details of shopping trip #1, the process ends at step 370.

Referring again to FIGS. 6 and 7, it is noted that the loyalty metrics displayed for each shopping trip in categories 622 and 722 represent an amount of alignment with a purchaser's preference for products, stores, or means of transportation, for example, per trip. As illustrated, the loyalty metrics range from “1” to “0”, with a larger number representing a shopping trip more closely aligned with a purchaser's preferences and a smaller number representing a shopping trip less closely aligned with the purchaser's preferences. However, other numbers or visual aids of the loyalty metric may be used. That is, among embodiments, the loyalty metric may be displayed using different colors or a percentage, for example, without limitation.

Thus, with reference to FIG. 6, for example, a purchaser is able to quickly determine that shopping trip #1 is less closely aligned with the purchaser's preferences than shopping trip #6. In other words, shopping trip #6 may include stops at the purchaser's preferred stores, while shopping trip #1 does not. Alternatively, shopping trip #6 may include stops at stores in which the purchaser is able to purchase preferred brand-name products, while shopping trip #1 requires the purchaser to purchase off-brand products.

With reference to the results of the embodiments described above, the purchaser is able to make the most cost-effective purchasing decisions, based on various factors including, but not limited to, the cost of the products to be purchased, travel time, travel cost, and time cost. Particularly, the purchaser is able to make the most cost-effective purchasing decisions in view of conditions unique to the purchaser such as a value of the purchaser's time and the purchaser's available transportation options, for example, in a short period of time.

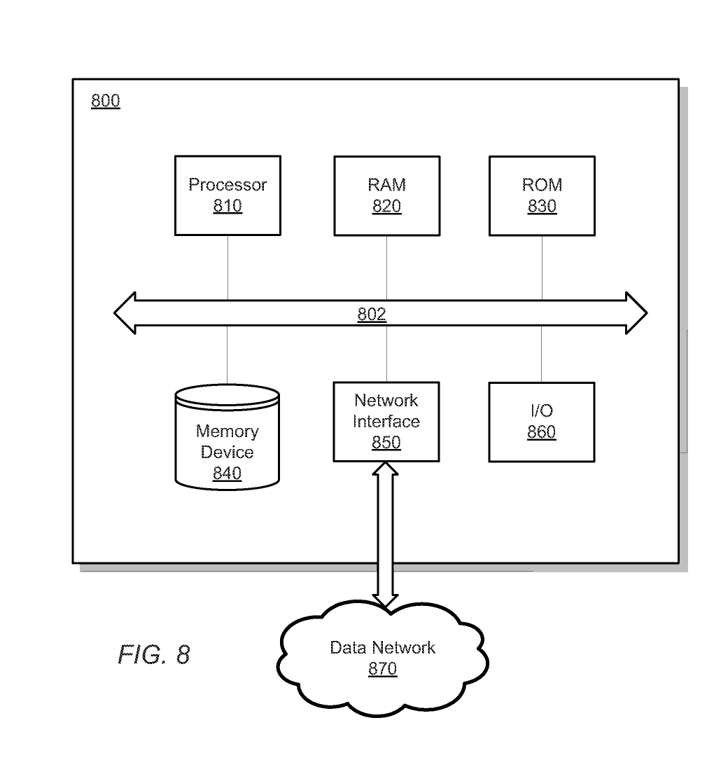

Turning to FIG. 8, an example hardware diagram of a general purpose computer 800 is illustrated. Any of the ranking and optimizing computing device 100, the client computing devices 130, or the servers 140 may be implemented, in part, using one or more elements of the general purpose computer 800. The computer 800 includes a processor 810, a Random Access Memory (“RAM”) 820, a Read Only Memory (“ROM”) 830, a memory device 840, a network interface 850, and an Input Output (“I/O”) interface 860. The elements of the computer 800 are communicatively coupled via a bus 802.

The processor 810 comprises any well known general purpose arithmetic processor or Application Specific Integrated Circuit (“ASIC”). The RAM and ROM 820 and 830 comprise any well known random access or read only memory device that stores computer-readable instructions to be executed by the processor 810. The memory device 830 stores computer-readable instructions thereon that, when executed by the processor 810, direct the processor 810 to execute various aspects of the present invention described herein. When the processor 810 comprises an ASIC, the processes described herein may be executed by the ASIC according to an embedded circuitry design of the ASIC, by firmware of the ASIC, or both an embedded circuitry design and firmware of the ASIC. As a non-limiting example group, the memory device 830 comprises one or more of an optical disc, a magnetic disc, a semiconductor memory (i.e., a flash based memory), a magnetic tape memory, a removable memory, combinations thereof, or any other known memory means for storing computer-readable instructions. The network interface 650 comprises hardware interfaces to communicate over data networks. The I/O interface 860 comprises device input and output interfaces such as keyboard, pointing device, display, communication, and other interfaces. The bus 802 electrically and communicatively couples the processor 810, the RAM 820, the ROM 830, the memory device 840, the network interface 850, and the I/O interface 860, so that data and instructions may be communicated among them. In operation, the processor 810 is configured to retrieve computer-readable instructions stored on the memory device 840, the RAM 820, the ROM 830, or another storage means, and copy the computer-readable instructions to the RAM 820 or the ROM 830 for execution, for example. The processor 810 is further configured to execute the computer-readable instructions to implement various aspects and features of the present invention. For example, the processor 810 may be adapted and configured to execute the processes described above with reference to FIGS. 2-5, including the processes described as being performed by the modules of the ranking and optimizing computing device 100. Also, the memory device 840 may store the data stored in the database 120.

Although embodiments of the present invention have been described herein in detail, the descriptions are by way of example. The features of the invention described herein are representative and, in alternative embodiments, certain features and elements may be added or omitted. Additionally, modifications to aspects of the embodiments described herein may be made by those skilled in the art without departing from the spirit and scope of the present invention defined in the following claims, the scope of which are to be accorded the broadest interpretation so as to encompass modifications and equivalent structures.

1. A method for ranking shopping trips, comprising:
receiving geographic location information;
receiving a product item identifier for each of a plurality of products to be purchased;
searching, by a computer, inventories of one or more retailers for the products to be purchased and compiling search results;
generating, by the computer, one or more shopping trips based on the search results and a compilation metric;
ranking the one or more shopping trips according to a least cost metric; and
displaying the ranked shopping trips.

2. The method of claim 1, wherein generating one or more shopping trips further comprises calculating costs of each of the shopping trips.

3. The method of claim 2, wherein
calculating costs of each of the shopping trips comprises calculating at least one of
a total cost for the products to be purchased,
a distance and time estimate for each of the shopping trips,
a time cost for each of the shopping trips, and
a transportation cost for each of the shopping trips, and
generating one or more shopping trips further comprises summing each of the calculated costs.

4. The method of claim 3, wherein the time cost of each of the shopping trips is calculated based on a determined value of an hour of time to a purchaser of the plurality of products.

5. The method of claim 3, wherein the transportation cost of each of the shopping trips is calculated based on one of the cost of walking, driving a personal automobile, and taking public transportation.

6. The method of claim 1, wherein the least cost metric comprises one of least overall total cost, least cost of the items to be purchased, least time, least number of retailers to attend, least total distance, and least transportation cost.

7. The method of claim 1, wherein the compilation metric comprises one of least overall total cost, least cost of the items to be purchased, least time, least number of retailers to attend, least total distance, and least transportation cost.

8. The method of claim 1, wherein the compilation metric comprises at least two compilation metrics among overall total cost, least cost of the items to be purchased, least time, least number of retailers to attend, least total distance, and least transportation cost.

9. A computer-readable storage device storing computer readable instructions thereon that, when executed by a processor, direct the processor to perform a method for ranking shopping trips, comprising:
receiving geographic location information;
receiving a product item identifier for each of a plurality of products to be purchased;
searching, by the processor, inventories of one or more retailers for the products to be purchased and compiling search results;
generating, by the processor, one or more shopping trips based on the search results and a compilation metric;
ranking the one or more shopping trips according to a least cost metric; and
displaying the ranked shopping trips.

10. The computer-readable storage device of claim 9, wherein generating one or more shopping trips further comprises calculating costs of each of the shopping trips.

11. The computer-readable storage device of claim 10, wherein
calculating costs of each of the shopping trips comprises calculating at least one of
a total cost for the products to be purchased,
a distance and time estimate for each of the shopping trips,
a time cost for each of the shopping trips, and
a transportation cost for each of the shopping trips, and
generating one or more shopping trips further comprises summing each of the calculated costs.

12. The computer-readable storage device of claim 11, wherein the time cost of each of the shopping trips is calculated based on a determined value of an hour of time to a purchaser of the plurality of products.

13. The computer-readable storage device of claim 11, wherein the transportation cost of each of the shopping trips is calculated based on one of the cost of walking, driving a personal automobile, and taking public transportation.

14. The computer-readable storage device of claim 9, wherein the least cost metric comprises one of least overall total cost, least cost of the items to be purchased, least time, least number of retailers to attend, least total distance, and least transportation cost.

15. The computer-readable storage device of claim 9, wherein the compilation metric comprises one of least overall total cost, least cost of the items to be purchased, least time, least number of retailers to attend, least total distance, and least transportation cost.

16. An apparatus for ranking shopping trips, comprising:
a location input module configured to receive geographic location information;
a product input module configured to receive a product item identifier for each of a plurality of products to be purchased;
a search and compilation engine configured to
search inventories of one or more retailers for the products to be purchased,
compile search results, and
generate one or more shopping trips based on the search results and a compilation metric;
a ranking module configured to rank the one or more shopping trips according to a least cost metric; and
an output module configured to display the ranked shopping trips.

17. The apparatus of claim 16, further comprising a cost module configured to calculate costs of each of the shopping trips.

18. The apparatus of claim 17, wherein the cost module is further configured to
calculate a total cost for the products to be purchased,
calculate a distance and time estimate for each of the shopping trips,
calculate a time cost for each of the shopping trips, and
calculate a transportation cost for each of the shopping trips.

19. The apparatus of claim 18, wherein the time cost of each of the shopping trips is calculated based on a determined value of an hour of time to a purchaser of the plurality of products.

20. The apparatus of claim 18, wherein the transportation cost of each of the shopping trips is calculated based on one of the cost of walking, driving a personal automobile, and taking public transportation.
